(19) United States
(12) Patent Application Publication
(10) Pub. No.: US 2026/0252462 A1
(43) Pub. Date: Aug. 27, 2026

(54) LEAN LARGE LANGUAGE MODEL DISTILLATION SYSTEMS AND METHODS

(71) Applicant: INTUIT INC., Mountain View, CA (US)

(72) Inventors: Matan VETZLER, Tel Aviv (IL); Shai ARDAZI, Tel Aviv (IL); Guy LEV, Tel Aviv (IL); Osnat Haj YAHIA, Tel Aviv (IL)

(73) Assignee: INTUIT INC., Mountain View, CA (US)

(21) Appl. No.: 19/065,142

(22) Filed: Feb. 27, 2025

(51) Int. Cl. G06F 11/34; G06F 8/60; G06F 16/3329

(52) U.S. Cl. CPC G06F 11/3428; G06F 8/60; G06F 16/33295

(57) ABSTRACT

At least one processor may configure a plurality of large language model (LLM) permutations by, for each of the plurality of LLM permutations, injecting at least one layer from a large-scale LLM into the LLM permutation, wherein the large-scale LLM has a greater number of parameters than each of the plurality of LLM permutations, and each of the plurality of LLM permutations has a different combination of layers from one another after the injecting. The at least one processor may evaluate performance of each of the plurality of LLM permutations, select a high-performing LLM permutation according to the evaluating, and deploy the high-performing LLM permutation during a runtime.

### BACKGROUND

Many large language models (LLMs) and other machine learning (ML) systems use very large models as a technique to improve output quality. For example, it is generally understood that the more parameters an LLM has, the more accurate and/or responsive its outputs will be. To this end, some LLMs have hundreds of billions of parameters across many layers. One disadvantage to this approach is that the improved outputs come at the cost of performance and/or deployability, as a larger model takes longer to process queries and requires more computing resources to deploy at runtime.

There are some known techniques to help smaller models (e.g., billions of parameters rather than hundreds of billions) perform more like larger models, but they require extensive custom training in the case of knowledge distillation, manual intervention and tuning in the case of layer-wise knowledge injection, or combining multiple models to prepare a response in the case of ensemble techniques.

### BRIEF DESCRIPTIONS OF THE DRAWINGS

FIG. 1 shows an example lean LLM distillation and inference system according to some embodiments of the disclosure.

FIG. 2 shows an example lean LLM distillation according to some embodiments of the disclosure.

FIG. 3 shows an example lean LLM distillation process according to some embodiments of the disclosure.

FIG. 4 shows an example lean LLM inference according to some embodiments of the disclosure.

FIG. 5 shows an example lean LLM inference process according to some embodiments of the disclosure.

FIG. 6 shows an example computing device according to some embodiments of the disclosure.

### DETAIL DESCRIPTIONS OF SEVERAL EMBODIMENTS

Systems and methods described herein may provide fully automated identification, provisioning, and runtime operation of optimal distillations from large LLMs to smaller LLMs. For example, embodiments described herein may perform an offline process where multiple permutations of layer injections from a larger model to a smaller model are tested on a labeled dataset. Embodiments described herein may identify the permutation that yields the best overall performance, based on evaluation metrics such as bilingual evaluation understudy score (BLEU), recall oriented understudy for gisting evaluation (ROUGE), and/or other benchmarks. This optimal layer configuration may be applied to the smaller model during runtime, enhancing its capabilities without needing subsequent training. Some embodiments may test swapping whole layers into and/or out of the smaller model and/or merging layers from the larger model with the smaller model layers. Systems and methods described herein may prepare small models having significant improvements in performance benchmarks over other models, including the larger foundational models, while maintaining a high degree of output accuracy and/or responsiveness.

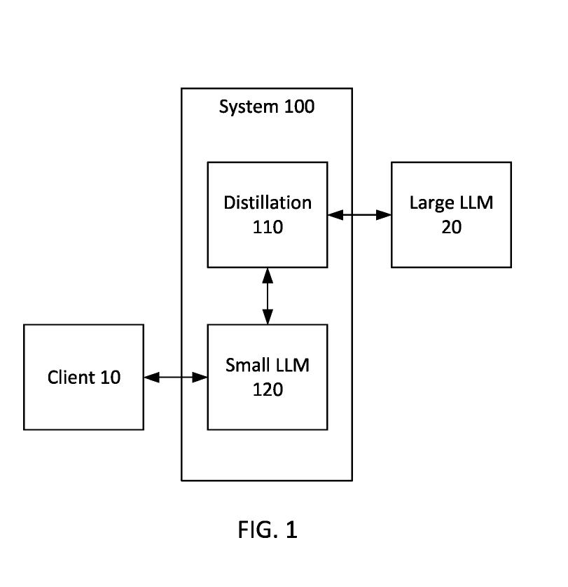

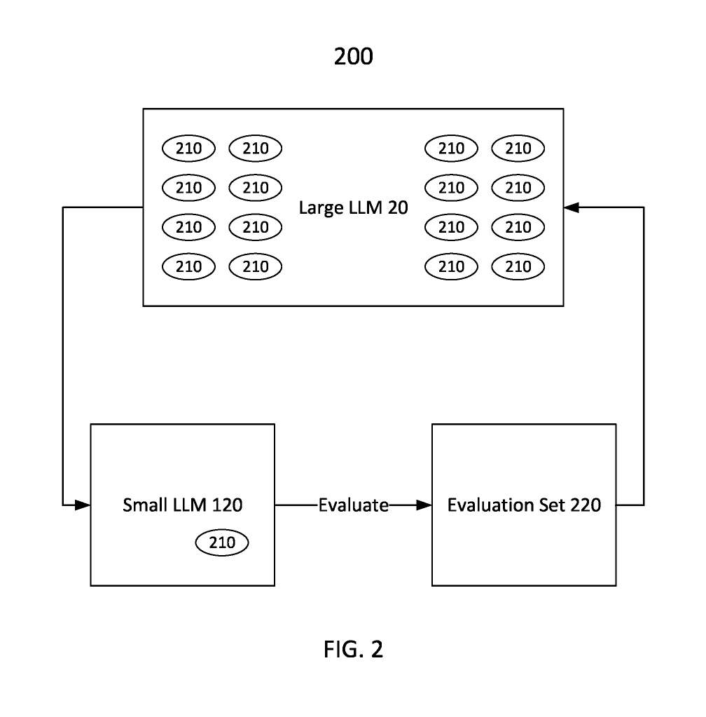

FIG. 1 shows an example lean LLM distillation and inference system 100 according to some embodiments of the disclosure. System 100 may include one or more modules, such as distillation 110 and/or small LLM 120. The elements of system 100 are described in greater detail below with respect to FIGS. 2-5, but in general, system 100 can create and/or provision small LLM 120 as a distillation of large LLM 20 (which may be hosted and/or operated externally to system 100 in at least some embodiments). System 100 can deploy small LLM 120, and client 10 can interact with small LLM 120 (e.g., sending user prompts to small LLM 120 and receiving responses from small LLM 120).

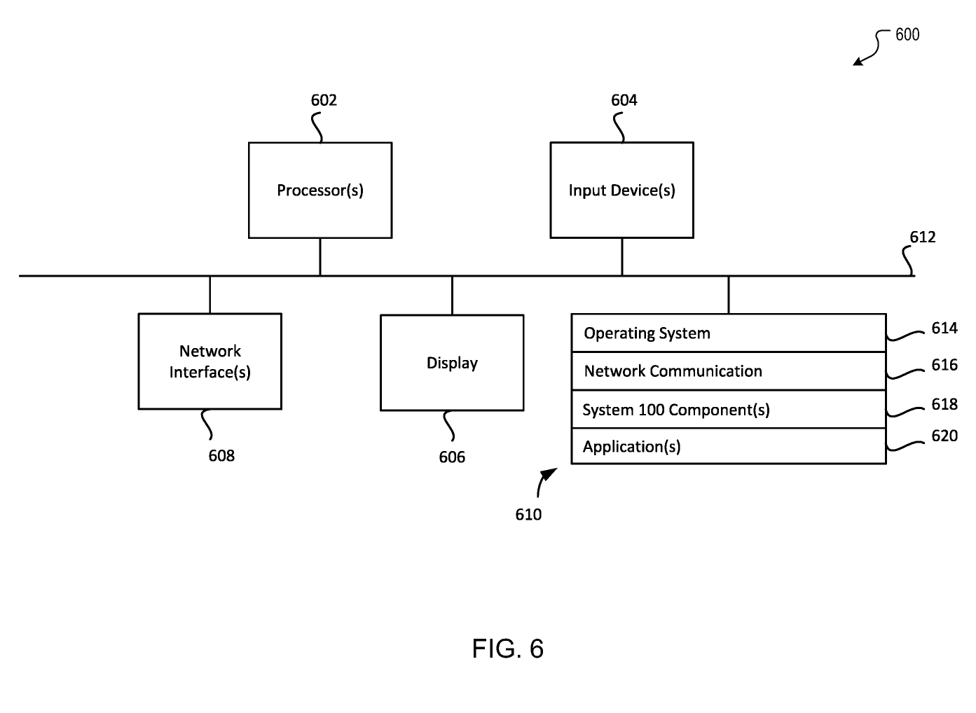

Illustrated components may include a variety of hardware, firmware, and/or software components that interact with one another. Some components shown in FIG. 1 may communicate with one another using networks. For example, system 100 may communicate with client 10 and/or large LLM 20 through one or more networks (e.g., the Internet, an intranet, and/or one or more networks that provide a cloud environment). In some embodiments, elements of system 100 may communicate with one another through the one or more networks. For example, once created, small LLM 120 may be deployed throughout a network (e.g., at one or more servers, which may be local servers) so that LLM processing requests by clients 10 can be processed by small LLM 120 without requiring communication to other system 100 components and/or without involving large LLM 20. Each component may be implemented by one or more computers (e.g., as described below with respect to FIG. 6).

Elements illustrated in FIG. 1 (e.g., system 100 (including distillation 110 and small LLM 120), client 10, and/or LLM 20) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one client 10, one large LLM 20, one distillation 110, and one small LLM 120 are illustrated, this is for clarity only, and multiples of any of the above elements may be present. In practice, there may be single instances or multiples of any of the illustrated elements, and/or these elements may be combined or co-located. For example, a plurality of clients 10 may send prompts to small LLM 120. In another example, multiple small LLMs 120 may be created, which may represent multiple local instances of a same small LLM 120 and/or different small LLMs 120 formed by integrating different parts of large LLM 20 into respective small LLMs 120 to enable different small LLM 120 specializations.

In the following descriptions of how the illustrated components function, several examples are presented. However, those of ordinary skill in the art will appreciate that these examples are merely for illustration, and the disclosed embodiments are extendable to other application and data contexts.

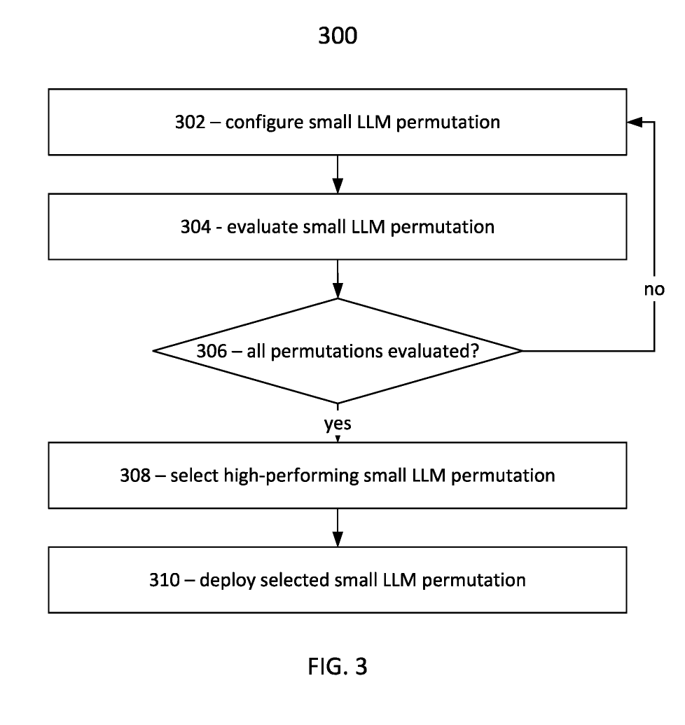

FIG. 2 shows an example lean LLM distillation 200, and FIG. 3 shows an example lean LLM distillation process 300, according to some embodiments of the disclosure. Lean LLM distillation 200 is an example showing the relationship between large LLM 20 and small LLM 120, while lean LLM distillation process 300 is an example of processing that system 100 may perform to implement lean LLM distillation 200. In at least some embodiments, system 100 may perform lean LLM distillation process 300 offline to identify optimal small LLM 120 configuration(s) before they are deployed for runtime prompt processing.

Large LLM 20 and small LLM 120 may have the same basic LLM architecture, for example having same layer structures, embeddings, transformer architectures, and/or other fundamental elements. However, large LLM 20 may have more parameters than small LLM 120. As a specific, non-limiting example, large LLM 20 may have approximately 405 billion parameters, while small LLM 120 may have approximately 8 billion parameters. As shown in FIG. 2, one or more layers 210 from large LLM 20 may be integrated into small LLM 120. FIG. 2 shows eight layers 120 in LLM 20, and one of these layers integrated into small LLM 120, but this is for illustration of the concept only, and in some embodiments the number of layers involved may be significantly higher.

As described in detail below, in lean LLM distillation process 300, system 100 may inject layers 210 from large LLM 20 into small LLM 120 through replacement and/or merging. System 100 may use evaluation set 220 to evaluate the performance of different layer injection permutations. Evaluation set 220 may be a dataset including human queries and gold labeled answers against which small LLM 120 performance may be evaluated. System 100 may use one or more performance metrics such as BLEU and/or ROUGE to identify a small LLM 120 permutation that performs best.

In some embodiments, system 100 may produce evaluation set 220. For example, system 100 may prompt large LLM 20 or another full-featured LLM to produce evaluation set 220. As a specific, non-limiting example (as other prompts may be more suitable for other subject matter), system 100 may use a prompt such as the following to produce evaluation set 220 when small LLM 120 is to be used to respond to queries in the tax preparation domain:

“Your goal is to construct a final US Tax course test. You will be provided with an article from various tax related websites from which you must derive one complex multiple choice question, and provide the answer for this question. \n The question should reflect potential queries that individuals might have regarding everyday tax issues, and tax forms. \n Your output should include four possible answers with only one correct response.”

Once large LLM 20 or other full-featured LLM produces an output according to the prompt above, in some embodiments, a user may check the output and modify it for accuracy and/or completeness as required.

Turning to FIG. 3, at 302, system 100 may configure a permutation of small LLM 120. For example, distillation 110 may inject at least one layer from large LLM 20 into the permutation of small LLM 120. As noted above, the large-scale large LLM 20 may have a greater number of parameters than the permutation of small LLM 120. In some embodiments, injecting the layer(s) may include replacing at least one preexisting layer in the permutation of small LLM 120 by the at least one layer from large LLM 20. In some embodiments, injecting the layer(s) may include merging at least one layer from large LLM 20 with at least one preexisting layer in the permutation of small LLM 120. Merging may be performed using any known or novel merging algorithm or combination thereof, including, but not limited to, linear merging, spherical interpolation, nearswap interpolation, task arithmetic, TIES, DARE and/or DELLA, passthrough, model breadcrumbs, model stock, SCE, etc. In some embodiments, injecting the layer(s) may include a combination of replacing and merging.

At 304, system 100 may evaluate performance of the permutation of small LLM 120 configured at 302. For example, distillation 110 may process a labeled dataset (e.g., evaluation set 220) using the permutation of small LLM 120 and apply at least one performance metric (e.g., BLEU, ROUGE, and/or LLM-AS-A-JUDGE) to outputs of the processing. For example, evaluation set 220 may include a few hundred samples of input and output pairs where the outputs are known to be true and correct. The performance metric may be any known or novel metric or combination thereof (e.g., BLEU, ROUGE, and/or LLM-AS-A-JUDGE) for open-ended samples. For samples with closed-ended outputs, where the answer is one of a number of possible answers such as in a multiple-choice question and answer set, the metric may whether small LLM 120 selected the correct answer from among the available answers.

At 306, system 100 may determine whether there are any other permutations of small LLM 120 to process. For example, distillation 110 may evaluate multiple combinations of injected layers 210 from large LLM 20. Any scheme for selecting layers 210 and/or combinations thereof may be used, such as trying all combinations of a certain number of layers 210, all combinations of layers 210 of a given type, etc. If small LLM 120 permutations remain to be processed, system 100 may repeat processing at 302 and 304 for another permutation. System 100 may perform processing at 302 and 304 for any number of small LLM 120 permutations having different combinations of layers from one another after the injecting.

At 308, system 100 may select a high-performing small LLM 120 permutation according to the evaluating performed at each iteration of 304. For example, distillation 110 may select, as the high-performing small LLM 120 permutation, a permutation having a highest score, a highest aggregate score, or a combination thereof in the at least one performance metric.

At 310, system 100 may deploy the high-performing small LLM 120 permutation during a runtime. As shown in the example process 300 of FIG. 3, the configuring, the evaluating, and the selecting may be performed prior to the runtime (e.g., as an offline process). Once deployed, the high-performing small LLM 120 permutation may process queries and/or other prompts, such as user prompts received from client 10.

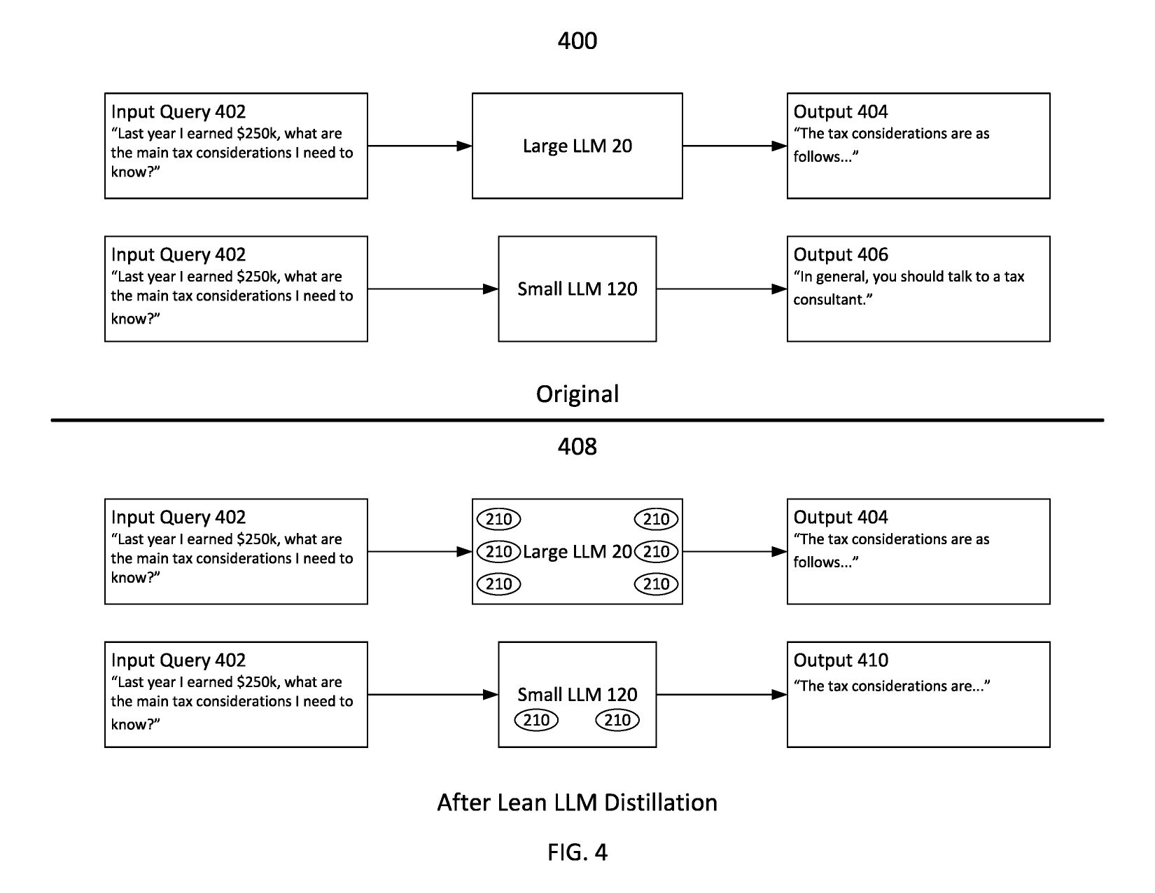

FIG. 4 shows an example lean LLM inference 400 according to some embodiments of the disclosure. FIG. 4 illustrates the difference between an original small LLM 120 without injection and a small LLM 120 after lean LLM distillation performed, for example, according to process 300 as described above.

In the original example 400, large LLM 20 may receive a query 402 asking a specific question. In this example, the specific question is a question in the tax preparation domain, although it should be understood that embodiments described herein may be applied to any subject matter domain. Because large LLM 20 is complex, with some 405 billion parameters, its output 404 may have specificity and detail (e.g., a listing of specific tax considerations applicable to the question in query 402). However, small LLM 120, with only about 8 billion parameters, may provide output 406 containing only general advice with limited relevance to query 402.

In the post-distillation example 408, small LLM 120 has been injected with layers 210 from large LLM 20 according to process 300. The layer injection has been optimized to deliver high performance, as described above. Accordingly, even in cases where output 410 of small LLM 120 lacks the complete detail of output 404 of large LLM 20, output 410 of small LLM 120 may still be specific and highly relevant to input query 402. Indeed, in some cases small LLM 120 and large LLM 20 may produce identical or very similar outputs after distillation.

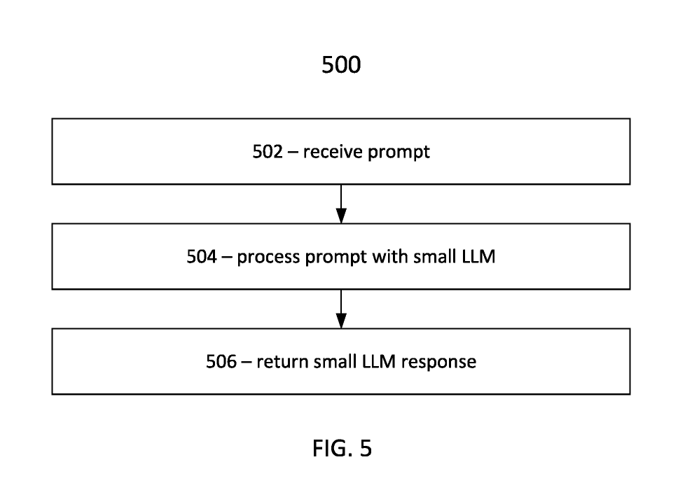

FIG. 5 shows an example lean LLM inference process 500 according to some embodiments of the disclosure. Small LLM 120 as configured by process 300 may be used to perform lean LLM inference process 500. At 502, system 100 may receive a prompt for processing by small LLM 120. For example, a user of client 10 may enter a prompt through a user interface. In at least some cases, client 10 and/or system 100 may perform prompt injection to modify the user’s prompt. Small LLM 120 may receive the prompt after prompt injection if applicable, or directly from the user interface if not.

At 504, system 100 may process the prompt. For example, small LLM 120 may process the prompt according to any known or proprietary LLM algorithm and/or tuning by which small LLM 120 is configured to operate. Small LLM 120 may use the layers 210 injected as described above (e.g., through process 300) to process the prompt. At 506, system 100 may return the response generated by small LLM 120 processing at 504. For example, small LLM 120 may provide the response to client 10, which may display the response in the user interface. Because small LLM 120 was prepared by offline process 300 prior to deployment, small LLM 120 can deliver results with enhanced performance without further training.

FIG. 6 shows a computing device 600 according to some embodiments of the disclosure. For example, computing device 600 may function as system 100 and/or any portion(s) thereof, or multiple computing devices 600 may function as system 100 and/or any portion(s) thereof.

Computing device 600 may be implemented on any electronic device that runs software applications derived from compiled instructions, including without limitation personal computers, servers, smart phones, media players, electronic tablets, game consoles, email devices, etc. In some implementations, computing device 600 may include one or more processors 602, one or more input devices 604, one or more display devices 606, one or more network interfaces 608, and one or more computer-readable mediums 610. Each of these components may be coupled by bus 612, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. In some embodiments, some or all devices shown as coupled by bus 612 may not be coupled to one another by a physical bus, but by a network connection, for example. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, telephony, etc.).

System 100 components 618 may include instructions for performing the processing described herein. For example, system 100 components 618 may provide instructions for performing any and/or all of processes 300 and/or 500 and/or other processing as described above. Application(s) 620 may be an application that uses or implements the outcome of processes described herein and/or other processes. In some embodiments, the various processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

What is claimed is:

1. A method comprising:
configuring, by at least one processor, a plurality of large language model (LLM) permutations by, for each of the plurality of LLM permutations, injecting at least one layer from a large-scale LLM into the LLM permutation, wherein the large-scale LLM has a greater number of parameters than each of the plurality of LLM permutations, and each of the plurality of LLM permutations has a different combination of layers from one another after the injecting;
evaluating, by the at least one processor, performance of each of the plurality of LLM permutations;
selecting, by the at least one processor, a high-performing LLM permutation according to the evaluating; and
deploying, by the at least one processor, the high-performing LLM permutation during a runtime.

2. The method of claim 1, wherein the injecting comprises at least one of:
replacing at least one preexisting layer in the LLM permutation by the at least one layer from the large-scale LLM; and
merging the at least one layer from the large-scale LLM with the at least one preexisting layer in the LLM permutation.

3. The method of claim 1, wherein the evaluating comprises:
processing a labeled dataset using each of the plurality of LLM permutations; and
applying at least one performance metric to outputs of the processing.

4. The method of claim 3, wherein the high-performing LLM permutation has a highest score, a highest aggregate score, or a combination thereof in the at least one performance metric.

5. The method of claim 3, wherein the at least one performance metric comprises at least one of a bilingual evaluation understudy score and a recall oriented understudy for gisting evaluation.

6. The method of claim 1, wherein the configuring, the evaluating, and the selecting are performed prior to the runtime.

7. The method of claim 1, wherein the deploying comprises processing, by the at least one processor, at least one query using the high-performing LLM permutation.

8. A system comprising:
at least one processor; and
at least one non-transitory computer-readable medium storing instructions that, when executed by the at least one processor, cause the at least one processor to perform processing comprising:
configuring a plurality of large language model (LLM) permutations by, for each of the plurality of LLM permutations, injecting at least one layer from a large-scale LLM into the LLM permutation, wherein the large-scale LLM has a greater number of parameters than each of the plurality of LLM permutations, and each of the plurality of LLM permutations has a different combination of layers from one another after the injecting;
evaluating performance of each of the plurality of LLM permutations;
selecting a high-performing LLM permutation according to the evaluating; and
deploying the high-performing LLM permutation during a runtime.

9. The system of claim 8, wherein the injecting comprises at least one of:
replacing at least one preexisting layer in the LLM permutation by the at least one layer from the large-scale LLM; and
merging the at least one layer from the large-scale LLM with the at least one preexisting layer in the LLM permutation.

10. The system of claim 8, wherein the evaluating comprises:
processing a labeled dataset using each of the plurality of LLM permutations; and
applying at least one performance metric to outputs of the processing.

11. The system of claim 10, wherein the high-performing LLM permutation has a highest score, a highest aggregate score, or a combination thereof in the at least one performance metric.

12. The system of claim 10, wherein the at least one performance metric comprises at least one of a bilingual evaluation understudy score and a recall oriented understudy for gisting evaluation.

13. The system of claim 8, wherein the instructions cause the configuring, the evaluating, and the selecting to be performed prior to the runtime.

14. The system of claim 8, wherein the processing further comprises processing at least one query using the high-performing LLM permutation during the runtime.

15. A non-transitory computer-readable medium storing instructions that, when executed by at least one processor, cause the at least one processor to perform processing comprising:
configuring a plurality of large language model (LLM) permutations by, for each of the plurality of LLM permutations, injecting at least one layer from a large-scale LLM into the LLM permutation, wherein the large-scale LLM has a greater number of parameters than each of the plurality of LLM permutations, and each of the plurality of LLM permutations has a different combination of layers from one another after the injecting;
evaluating performance of each of the plurality of LLM permutations;
selecting a high-performing LLM permutation according to the evaluating; and
deploying the high-performing LLM permutation during a runtime.

16. The non-transitory computer-readable medium of claim 15, wherein the injecting comprises at least one of:
replacing at least one preexisting layer in the LLM permutation by the at least one layer from the large-scale LLM; and
merging the at least one layer from the large-scale LLM with the at least one preexisting layer in the LLM permutation.

17. The non-transitory computer-readable medium of claim 15, wherein the evaluating comprises:
processing a labeled dataset using each of the plurality of LLM permutations; and
applying at least one performance metric to outputs of the processing.

18. The non-transitory computer-readable medium of claim 17, wherein the high-performing LLM permutation has a highest score, a highest aggregate score, or a combination thereof in the at least one performance metric.

19. The non-transitory computer-readable medium of claim 17, wherein the at least one performance metric comprises at least one of a bilingual evaluation understudy score and a recall oriented understudy for gisting evaluation.

20. The non-transitory computer-readable medium of claim 15, wherein the processing further comprises processing at least one query using the high-performing LLM permutation during the runtime.
